(19) United States
(12) Patent Application Publication
(10) Pub. No.: US 2017/0081888 A1
(43) Pub. Date: Mar. 23, 2017

(54) EMERGENCY LOCKING DEVICE FOR SWINGING DOORS

(71) Applicants: Larry Dean Adams, Idalou, TX (US); Tim Adams, Idalou, TX (US)

(72) Inventors: Larry Dean Adams, Idalou, TX (US); Tim Adams, Idalou, TX (US)

(21) Appl. No.: 15/045,047

(22) Filed: Feb. 16, 2016

Related U.S. Application Data
(60) Provisional application No. 62/222,389, filed on Sep. 23, 2015.

(51) Int. Cl. E05C 19/18; B60R 25/01

(52) U.S. Cl. CPC E05C 19/188; B60R 25/01

(57) ABSTRACT

A device and method for the protection of individuals in a room having an outward swinging door is presented. The device includes a central chamber for the surrounding of a door handle, a first flange for extension from the central chamber and contacting the door, and a second flange for extension from the central chamber and contacting the door frame. The two flanges are relatively parallel and create a binding force around the handle as the door is opened, such that the door is prevented from opening. An optional slot is included to accommodate handles with levers. In operation, the device is lowered over the handle and held in place by gravity. It symmetric design allows it to function with both left handed and right handed opening outward doors.

### CLAIM OF PRIORITY

This application claims the benefit of U.S. Provisional Application No. 62/222,389, filed 23 Sep. 2015. The information contained therein is hereby incorporated by reference.

### BACKGROUND

1. Field of the Invention

The present application relates to a locking device, and more particularly to a device used to lock an outward swinging door.

2. Description of Related Art

The desire to lock a door for privacy, security, or any other purpose has been held by people for ages. Various different methods of locking a door have been imagined and used. For example, today door handles usually include locks to prevent the handle from rotating. Deadbolts are used as another form of protection to prevent injury. At times these are inadequate or unavailable to be used on a door. Therefore, an additional measure of protection is desired. It is not uncommon for some additional security devices to entail a bar braced under the door handle and into the ground. However, this only works with inward swinging doors where the direction of swing pushes against the rigid bar. This fails to work with outward swinging doors where the swing pulls away from the bar. Outward swinging doors are common in places such as schools. Efforts to add additional security measures to outward swinging doors typically involve modification to the door area, including the door, door frame, or neighboring walls. Although strides have been made to increase security for doors, primarily such measures have been made for inward swinging doors. Additionally, an additional security device to operate with outward security doors is needed that does not require modifications to existing doorways.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a locking device according to the preferred embodiment of the present application.

FIG. 2 is an additional perspective view of the locking device of FIG. 1.

FIG. 3 is a front view of the locking device of FIG. 2.

FIG. 4 is a side view of the locking device of FIG. 2.

While the device and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The device and method in accordance with the present application overcomes one or more of the above-discussed problems commonly associated with traditional security devices for doors. In particular, the device is configured to operate without any modification to the doorway. The device is designed to overlay the handle portion and create a binding force between the door and the door frame that prevents the door from opening. The device is easily installed and removed. These and other unique features of the device are discussed below and illustrated in the accompanying drawings.

The device and method will be understood, both as to its structure and operation, from the accompanying drawings, taken in conjunction with the accompanying description. Several embodiments of the device may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The device and method of the present application is illustrated in the associated drawings. The device includes a first flange and a second flange extending out from a central chamber. The flanges each contact either a door or the door frame. The central chamber includes one or more slots to slide between the handle and the door, such that the handle is retained within the central chamber. The device includes a coating to assist in preventing marring of the door or door frame. Additional features and functions of the device are illustrated and discussed below.

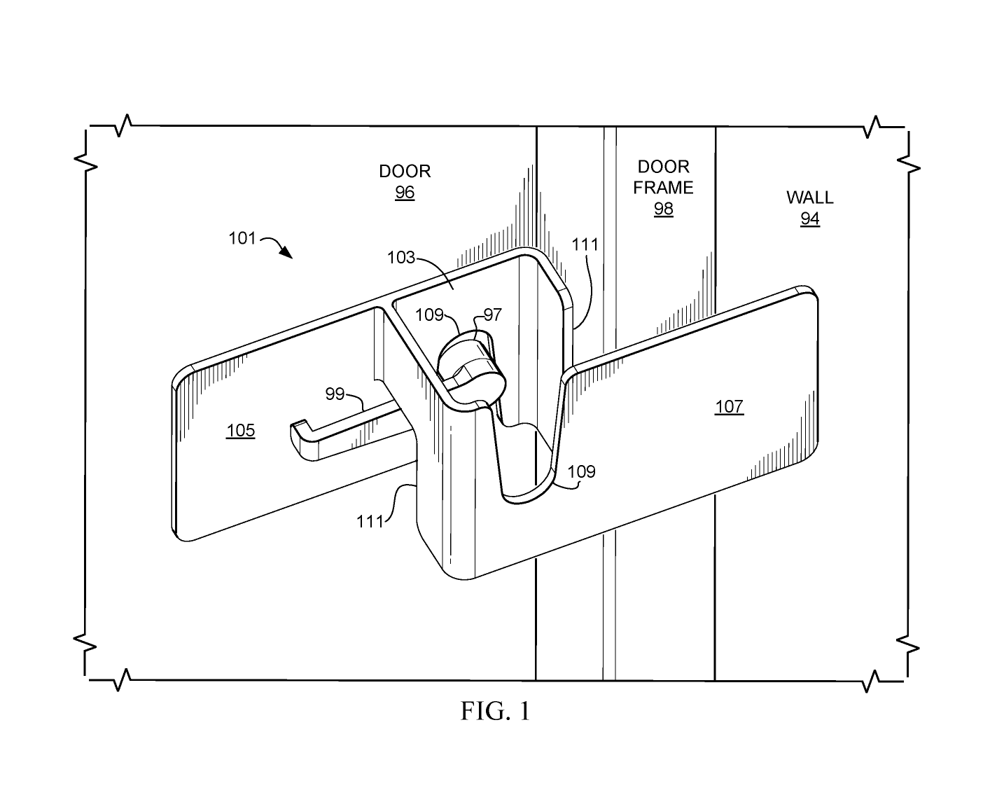

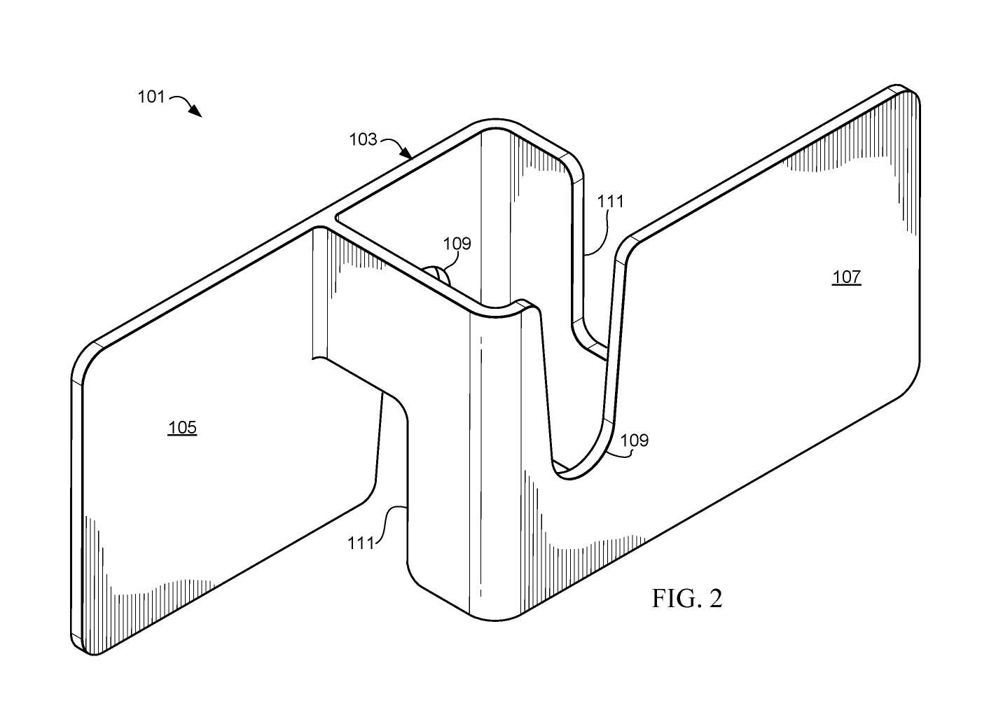

Referring now to the drawings wherein like reference characters identify corresponding or similar elements in form and function throughout the several views. FIGS. 1-4 illustrate assorted views of locking device 101 perspective view of the vehicle locking device 101 of the present application. In FIG. 1, device 101 is illustrated in an operable position in communication with a door 96. Device 101 is seen in communication also with door frame 98 and wall 94. Device 101 has slid over handle 99 and in particular to the base portion 97 of handle 99. It is understood that the shape of handle 99 may be varied and come in different shapes. Device 101 is designed to be operable with different styled handles.

Device 101 includes a central chamber 103, a first flange 105, and a second flange 107. Chamber 103 is configured to surround a portion of door handle 99 in communication with door 96. First flange 105 is configured to extend out from central chamber 103 along an interior face of door 96. Second flange 107 is configured to extend out from central chamber 103 in communication with door frame 98 and also optionally with wall 94. First flange 105 and second flange 107 are ideally parallel to one another, however they are also offset so as to not be in the same planar alignment. Each extends out in an opposing direction to that of the other flange. Device 101 is designed such that at a time of emergency, it may be placed over and around handle 99 such that at the time of an attempt to open the door, device 101 creates a binding force on door 96 from flanges 105 and 107.

Central chamber 103 is configured to have a relatively elongated shape with a hollow central opening. Both the top and bottom are left open to permit the door handle to slide into the open volume of chamber 103. Each flange 105 and 107 extends out from an opposite side of chamber 103. It is understood that other shapes, besides the illustrated rectangular shape, are possible. Such shape has been used because it is simple to fabricate and provides adequate room for handle 99. Additionally, it allows device 101 to have a degree of symmetry such that device 101 is operable with both left handed and right handed swinging outward doors. Device 101 may merely be rotated and/or flipped over to accommodate each type of swinging door.

Chamber 103 includes a first slot 109 configured to pass through the wall of chamber 103. Slot 109 extends from either an upper or lower surface (depending on orientation) and passes down into the length of the wall, thereby forming a void space. The shape of slot 109 may vary from shapes having parallel sides or a form of tapered sides, such that slot 109 is narrower at its apex than at its opening. In the figures, slot 109 includes tapered sides so as to permit slot 109 to accommodate different sized handles 99 and base portion diameters. First slot 109 is in the same plane as first flange 105. Slot 109 passes over base portion 97 while first flange 105 runs along door 96. Chamber 103 extends outward from door 96 a distance approximately equal to the thickness of door frame 98, where flange 107 protrudes forth.

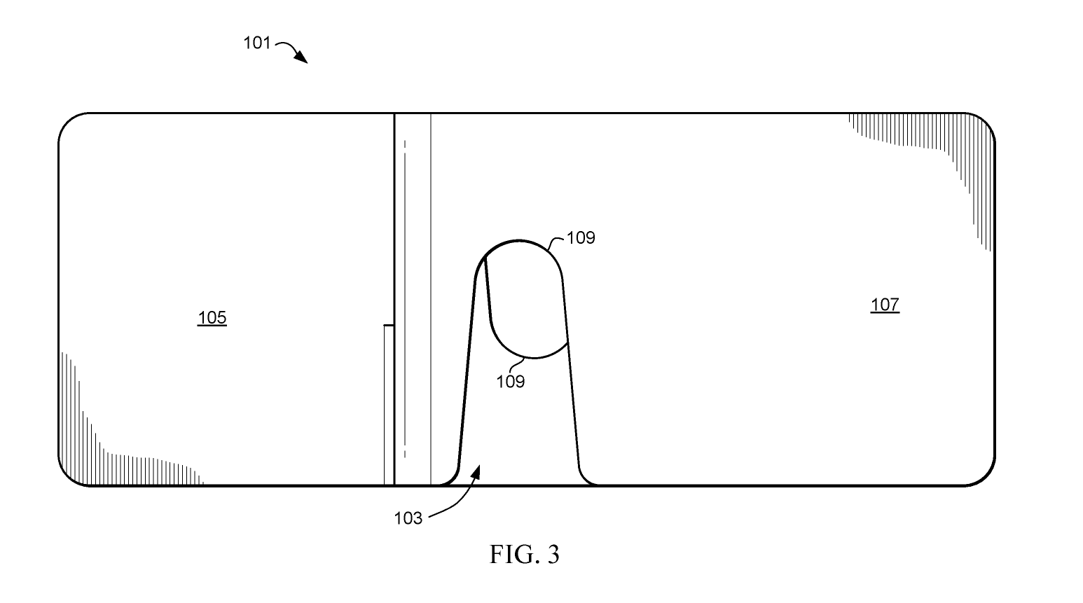

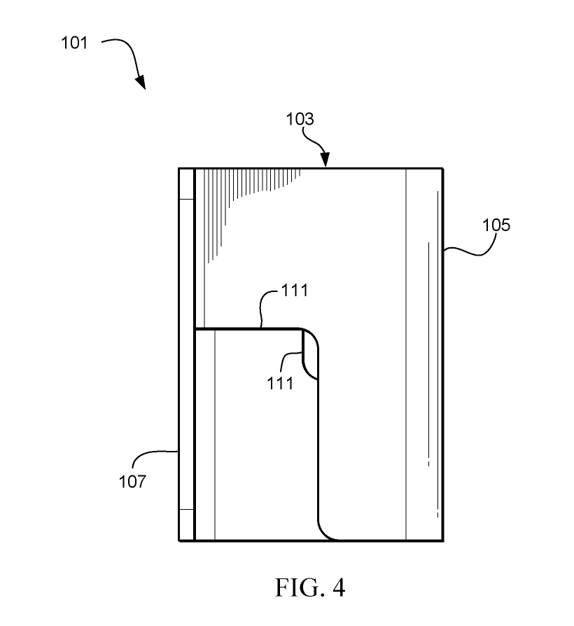

As seen in FIG. 1, handle 99 was shaped to have a lever portion. The lever portion was larger than the internal volume of chamber 103. Chamber 103 may then optionally include a second slot 111 configured to pass through the wall of chamber 103 and extend up the wall from a matching surface as slot 109. Slot 111 also forms a void space. Therefore, where handle 99 includes a lever portion, the lever portion and the base portion of handle 99 can slide up into slots 109 and 111 upon installation. It is important to note that slot 111 is perpendicular to that of flange 105 and 107. However, where chamber 103 is formed into a different shape, the precise angle relative to flanges 105 and 107 may vary. Slots 109 and 111 are parallel to the plane of flanges 105 and 107. It is also understood that the symmetry of device 101 allows for slots 109 and 111 to be optionally formed into opposing sides of chamber 103. This is seen more clearly in the front view and side view of FIGS. 3 and 4 respectively. Slot 111 also may be contoured so as to include a tapered profile, such that slot 111 is narrower at its apex than at its opening. The sides of slot 111 are not herein limited to the particular described contour, for example the sides may be parallel.

In use, device 101 is designed to be quick and easy to place around the door handle. Device 101 does not require the modification of the door assembly (i.e. door 96, door frame 98, wall 94, and even the floor) to use. In operation, the device is lowered over the handle and held in place by gravity. A coating may be applied to various surfaces of device 101 to prevent marring of the surfaces of the door assembly. A particular application of device 101 for use in schools. School classrooms typically have doors that are outward swinging wherein the door opens into the hall as opposed to the classroom. In emergency situations it can become necessary that the classrooms become locked to protect the children from an outside threat (i.e. a gunman). Typical handle locks are easily overcome. In such situations, a teacher is able to obtain the device and place it around the handle. If the handle lock is compromised, the unauthorized intruder would be stopped from opening the door by the binding force around the handle from flanges 105 and 107 contacting the door and door frame respectively. Other situations may exist but this herein serves as merely a single example of the benefit of device 101. It requires no modification and is quick to set up and fully removable.

Device 101 may be formed and created in different ways. One such way includes the obtaining of a first member and a second member of material. Ideally these are metallic in nature to provide exceptional strength properties and resistance to moment forces. The first member and the second member are similar to flanges 105 and 107. Both members may be bent at one end to a predetermined angle to form a shape similar to and “L”. The bent ends may be attached to the opposing member to form chamber 103. The method of coupling may be from a fastener or through a welding process. The shape of chamber 103 depends on the angle of the bend. Flanges 105 and 107 are defined as the end opposite each bent end that extends beyond chamber 103. One or more slots 109, and optionally 111, are also created on or more members.

It is important to note that device 101 may be formed from any number of materials, such as aluminum, metals, steel, carbon fiber, etc. Additionally, device 101 is scalable to fit any size door assembly. The length, width, and depth of device 101 may be adjusted accordingly. Device 101 may be formed from a cast, welded together, extruded, or fastened through one or more processes.

The current application has many advantages over the prior art including at least the following: (1) a robust locking device for any outward swinging door; (2) simple and quick to install; (3) optional slots to accommodate different styled handles; and (4) ability to protect and secure individuals during emergency situations.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A locking device, comprising:
a central chamber having a plurality of sides and defining a central volume;
a first flange configured to extend out from the central chamber parallel to a first side; and
a second flange configured to extend out from the central chamber parallel to a second side, the second flange being offset from the first flange, the second flange extending an opposite direction than that of the first flange.

2. The device of claim 1, wherein the central chamber includes a first slot parallel to and in the same plane as the first flange.

3. The device of claim 2, wherein the first slot is tapered to accommodate different sized base portion diameters, such that an apex of the first slot is narrower than an opening of the first slot.

4. The device of claim 1, wherein the central chamber includes a second slot perpendicular to and adjacent the first flange.

5. The device of claim 4, wherein the second slot is tapered, such that the apex of the second slot is narrower than an opening of the second slot.

6. The device of claim 1, wherein the central chamber is integrally bonded to the first flange and the second flange.

7. The device of claim 6, wherein the bond is formed by a fastening the first flange and the second flange to the central chamber.

8. The device of claim 6, wherein the bond is formed from a welding process.

9. The device of claim 1, wherein the internal chamber is formed from the bending of the first flange and the second flange.

10. The device of claim 1, wherein at least one from the group consisting of the central chamber, the first flange, and the second flange is coated to prevent marring of a surface.

11. The device of claim 1, further comprising:
a third slot formed in the central chamber opposite that of the first slot, the third slot being inverted from the first slot.

12. The device of claim 1, further comprising:
a fourth slot formed in the central chamber opposite that of the second slot, the fourth slot being inverted from the second slot.

13. A method of forming a locking device, comprising:
obtaining a first member and a second member;
coupling the first member and the second member along so as to form a central chamber, the central chamber having a first flange and a second flange, the second flange being offset from the first flange and extending in an opposing direction to that of the second flange; and
creating one or more slots in the first member.

14. The method of claim 13, wherein the first member is bent.

15. The method of claim 13, wherein the one or more slots are tapered, such that an apex of the one or more slots are narrower than an opening.

16. The method of claim 13, wherein the device slides down over a door handle.

17. The method of claim 13, wherein the first member and the second member are coupled via a welding process.

18. The method of claim 13, wherein the first member and the second member are coupled via a fastening process.

19. The method of claim 13, wherein the first member and the second member are coupled such that both are integral to one another.
